(19) United States
(12) Patent Application Publication
(10) Pub. No.: US 2015/0159010 A1
(43) Pub. Date: Jun. 11, 2015

(54) CONDUCTING INTERPENETRATING POLYMER NETWORKS, RELATED METHODS, COMPOSITIONS AND SYSTEMS

(71) Applicant: Sergei Rudenja, Winnipeg (CA)

(72) Inventor: Sergei Rudenja, Winnipeg (CA)

(21) Appl. No.: 14/098,520

(22) Filed: Dec. 5, 2013

(51) Int. Cl. C08L 67/02; H01B 1/12

(52) U.S. Cl. CPC C08L 67/02; H01B 1/124; C08L 2205/04; C08L 2205/025

(57) ABSTRACT

The invention provides conducting polymeric interpenetrating network (IPN), and related methods and composition. The conductive surface of polymer of this invention comprises an interpenetrating network of two or more polymers, wherein at least one of the polymer networks is conducting polymer. Also provided is a method of producing a conducting surface on otherwise insulating bulk polymer, combining a first polymeric network with a second polymeric network, wherein the first or second polymeric network is based on a conducting polymer. The conducting surfaces are intended for use in flexible and wearable electronics; in photonics and photovoltaics; signal dissipation and suppression, corrosion protection; ionic and catalytic exchange; electrodes, filters and membranes; finishing textiles, bandages and carpets, healthcare devices, sensors. The present application also discloses devices manufactured from IPN conducting polymers and uses thereof.

### CROSS REFERENCE

This application claims priority to U.S. Provisional Patent Application Nos. 61/734,208, filed Dec. 6, 2012, which is incorporated by reference herein in its entirety.

### BACKGROUND OF THE INVENTION

Functional polymers received much attention in recent years, as provide new properties to already existing polymers. The functionality of the polymers can be achieved through the introduction of chemical groups that alter the functions of polymers while they will retain their basic properties. The polymers can be modified throughout their bulk structure or on their surface. In both cases, after polymerization, the manipulation over chemically inert polymers requires a significant stimulus (heat, radiation, plasma treatment, etc.) that may disrupt the chemical structure of the polymers, and thus degrade the inherent properties of the polymers. The current application introduces the conducting IPN polymers and provides the method of conjoining of fully-cured polymers in the manner of preserving their bulk properties while gaining conductivity on the surface.

In recent years, a novel approach has emerged, namely interpenetrative-network polymerization (IPN), which provides a mutual mechanistic interpenetration of solid polymers and interlocking in the structure of each other (Sergei Rudenja. Nan Zhao and Song Liu, Surface Interpenetration of Polyacrylamide Network into Poly(ethylene terephthalate) substrate, European Polymer Journal, 46, 2078 (2010)). The method is characterized in that the monomers/organic precursors to polymers are infused into swollen structure of fully-cured polymer by dipping into solution of said above monomers, water-based or dissolved in polar/non-polar organic solvents, and driving the monomers into the swollen substrate polymer by surface forces, capillary forces, osmosis, electrophoresis, or external pressure.

The list of the bulk insulating materials includes, but not limited to thermoplastic polymers, thermoset polymers and elastomers. For example, a group of semicrystalline thermoplastic polymers such as poly(ethyleneterephthalate) (PET), polypropylene (PP), poly(methyl methacrylate) (PMMA), nylon, polyvinyl chloride (PVC), Teflon, and polyurethane. They are flexible, resilient, durable, and resist biological degradation; and already found use in wide range of medical applications: from surgical drapes, lightweight orthopedic casts, sutures, vascular grafts, ligament and tendons prostheses.

However, on a downside, these polymers may become a breeding ground for bacteria and sites of blood coagulation, due to their low biocidal properties.

The thermosetting polymers/ elastomers are widely used in microelectronics, flexible electronics, and insulating materials.

The solution comes through the surface modification or the polymers, e.g. interpenetrating networking with acrylamide, which reportedly suppresses bacterial growth on the surface IPN polymer. The functionalization of the surface, PET in this instance, has been achieved by swelling of the substrate polymer in solvent, which concurrently was used as a media for acrylamide monomers and photoinitiator for following up crosslinking in UV light, which represents a mutual chemical path (Song Liu, Nan Zhao and Sergei Rudenja, Surface Interpenetrating Networks of Poly(ethylene terephthalate) and Polyamides for Effective Biocidal Property, MACROMOLECULAR CHEMISTRY & PHYSICS, 211, 286 (2010)). Alternatively, the monomers can be introduced after the swelling procedure completion, or by individual chemical path.

The IPN polymerization is an economical way of surface modification with a limited impact on the bulk properties of substrate polymer. As a method the IPN polymerization is superior to synthetic and grafting methods because high utilization of functional monomers and lower temperatures of processing (Sun, G., Liu, S. Acyclic N-halamine-containing Microbiocidal Polymers and Antibacterial Materials, 19.04.2007, WO 2007/044973 A2).

The described process is a contrary to the common grafting techniques that relies on disruption of the polymer chains on the surface of materials to create the attachment cites for other substances, including conducting polymers (H\dot{a}kansson, Eva, Amiet, Andrew, Nahavandi, Saeid and Kaynak, Akif 2007-01, Electromagnetic interference shielding and radiation absorption in thin polypyrrole films, European Polymer Journal, vol. 43, no. 1, pp. 205-213).

The invention addresses another fundamental property of the polymers, and plastic in general—their inability to pass charge or being insulators. The present invention overcomes this limitation through the surface modification of insulating bulk polymers by conducting interpenetrating networks comprised of conducting conjugated polymers. The common electronic feature of pristine (undoped) conducting polymers is the p-conjugated system, which is formed by the overlap of carbon p_{z} orbitals and alternating carbon-carbon bond lengths. The conductivities of the pristine conjugated polymers arise through the process of doping, with the conductivity increasing with a boost of the doping levels. Following the polymerization of the polymer, two types of doping can be distinguished: internal doping or self-doping, and external doping, which may occur in a process of polymerization or concurrently with polymerization. The external doping may also occur in aftermath of the polymerization, when external ions get involved on the sites of excessive charge along the polymer chain. The doping may occur in the course of chemical/electrochemical oxidation, charge injection, or photoexcitation, etc.

The conjugated conductive polymers include, but not limited to, trans- and cis-polyacetylene RCH), [(CH)ₓ]; polythiophene (PT); emeraldine salt of polyaniline (PANI); poly(3,4-ethylenedioxythiophene) (PEDOT); poly(pyrrole)s (PPY); poly(p-phenylene sulfide) (PPS); poly(p-phenylene vinylene) (PPV), and others less common conductive polymers. The chemical structure of the most common conductive polymers in their pristine (undoped) form can be seen in FIG. 1, where the chains in square braces represent monomers-precursors of said above polymers.

The monomer precursors of the above polymers interlock with the chains of swollen substrate polymers into single entity, giving new properties to the surface of what becomes the functional polymer. Functional polymers contain chemical groups that serve a specific function, whether biological, pharmacological, electrical or other. Intelligent polymers have the capacity of selecting and executing certain specific functions. They respond to an external stimulus by variations in their structure, composition or properties. The stimuli that cause these variations are quite diverse, but not limited to a shift in pH, solvent, temperature, electric or magnetic fields, or light, etc.

### SUMMARY OF THE INVENTION

In one aspect, the present invention provides conductive interpenetrating network (IPN) of polymers, comprising an interpenetrating network of two or more polymers, wherein at least one of the polymer networks is conducting polymer. As such, in preferred embodiment, the present invention provides a conductive polymer with insulating bulk body and conductive surface due to IPN modification. The example of an interpenetrating network (IPN) formation is presented in diagram on FIG. 2. It consists in three main stages: swollen insulating polymer 101, penetration with monomers 110 precursors to conducting polymer, and cross-linked conducting polymer on the surface of insulating polymer 120. The final entity 120 is a bulk insulating polymer with a conductive surface confined within 100 nm (nanometers) into the bulk of insulating polymer.

In another embodiment, the newly produced conductive surface can be furthered into fully developed layers of metals and polymers to expand the surface modified layer into hundreds of nanometers, up to 1-10 micrometers, using the initial IPN as a substrate for the deposition of conductive layers by methods of self assembling on statically charged surfaces, electroplating and vacuum metallisation on biased substrates, or thereof.

In a different embodiment, the modified conductive surface can be used itself as an electronic device, which includes, but not limited, to sensors, newly discovered thin film plasmonic devices (TFPD) on a basis of conducting polymers (Rudenja Sergei and Freund Michael, Plasmonic Device, System and Methods, U.S. Pat. No. 8,314,445, Nov. 20, 2012), layers for electromagnetic radiation absorption, and electrochromic windows, and thereof.

In additional embodiment, the present invention provides biocidal polymers that suppress a bacterial growth in bandages, medical equipment, food processing equipment and facilities, and the application of thereof.

One more embodiment arises from the ability of the modified polymers to attract charged particles, ions and polar molecules, and therefore, the present invention provides, but not limits the use of the polymers as filtering materials, toxic metals recovery, medical dialysis and diffusion dialysis, chemical substances separation, sequestering of gases, and uses thereof.

In a second aspect, the present invention provides a method of producing a conducting surface on otherwise insulating bulk polymer, combining a first polymeric network with a second polymeric network, wherein the first or second polymeric network is based on a conducting polymer. In this embodiment, the method is characterized in that the monomers/organic precursors to conjugated polymers are infused into swollen structure of polymer insulating substrate by dipping into solution of said above monomers, water-based or dissolved in polar/non-polar organic solvents, and driving the monomers into the swollen substrate polymer by surface forces, capillary forces, osmosis, electrophoresis, or external pressure. The said above monomers can be later polymerized into conducting polymer under electrochemical control, UV and heat radiation, plasma discharge, ozone oxidation, or chemical oxidation, in the presence of initiators, or catalysts, or metal ions and/or active radicals.

The processing routes are outlined, but not limited to FIG. 3, and include subsequent steps: swelling of substrate polymer under external stimulus, individually or mutually with infusing monomers-precursors to conducting polymers, as so exposure to solvent, change in pH, heat or light radiation, electrical or magnetic fields, all forms of ambient or controlled atmosphere; or in the course of polymers production as so spin coating; casting, molding or rolling; mechanical compounding, or combination of there off; infusion of monomers of the swollen polymer, e.g. by the solution containing monomers; polymerisation of conducting polymers by the methods listed in the summary of the invention concurrently with doping processes.

### BRIEF DESCRIPTION OF DRAWINGS

The accompanying drawings, which are incorporated in and constitute a part of this specification, show certain aspects of the subject matter disclosed herein and, together with the detailed description that follows, illustrate and explain some of the principles, structures, features, and/or advantages associated with one or more implementations of the disclosed subject matter. Wherever possible, similar reference numerals in the drawings are used to denote identical or similar structures or other features of the described subject matter. In the drawings:

FIG. 1 shows the chemical repeat units of the pristine forms of several families of conducting polymers—that is, trans- and cis-polyacetylene [(CH)ₓ]; polythiophene (PT); polypyrrole (PPy); and the leuco-emeraldine-base (LEB), emeraldine-base (EB), and pernigraniline-base (PNB) forms of polyaniline (PAN).

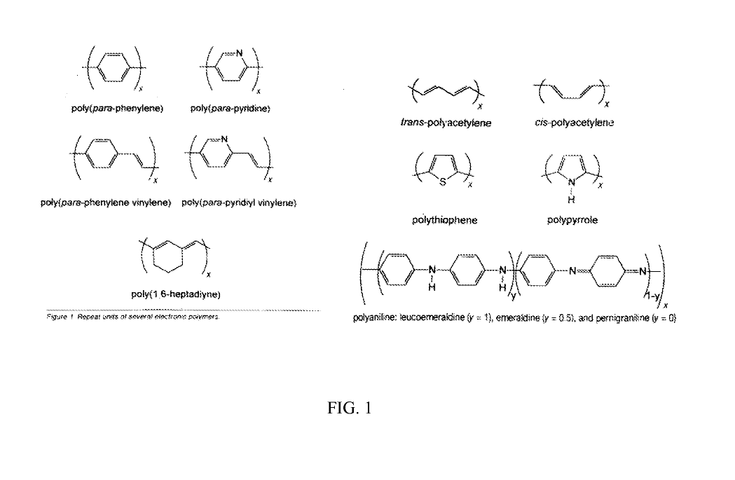

FIG. 2 is a diagram showing an example of an interpenetrating network (IPN) formation in three main stages; swelling of the substrate polymer 101, penetrating with monomers 110, and crosslinking into new entity 120.

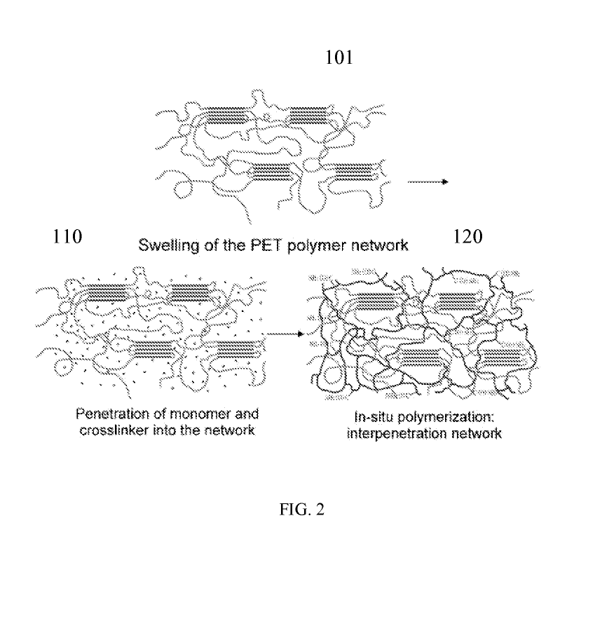

FIG. 3 is a process flow diagram illustrating a method producing a conducting surface on otherwise inert polymers into conductive state by interlocking with structure of conducting conjugated polymers, where 301 is an initial polymer substrate, 310 is a step of swelling the polymer structure, 305 is an introduction of monomers—precursors to conducting polymers by mutual or individual chemical path, 320 is step of penetration of above monomers into the swollen structure of substrate polymer, 325 is optional initiators/facilitators to the following polymerisation procedure, 330 is a crosslinking or polymerisation of conducting polymers concurrently with doping, 340 final inert substrate polymer with conductive surface.

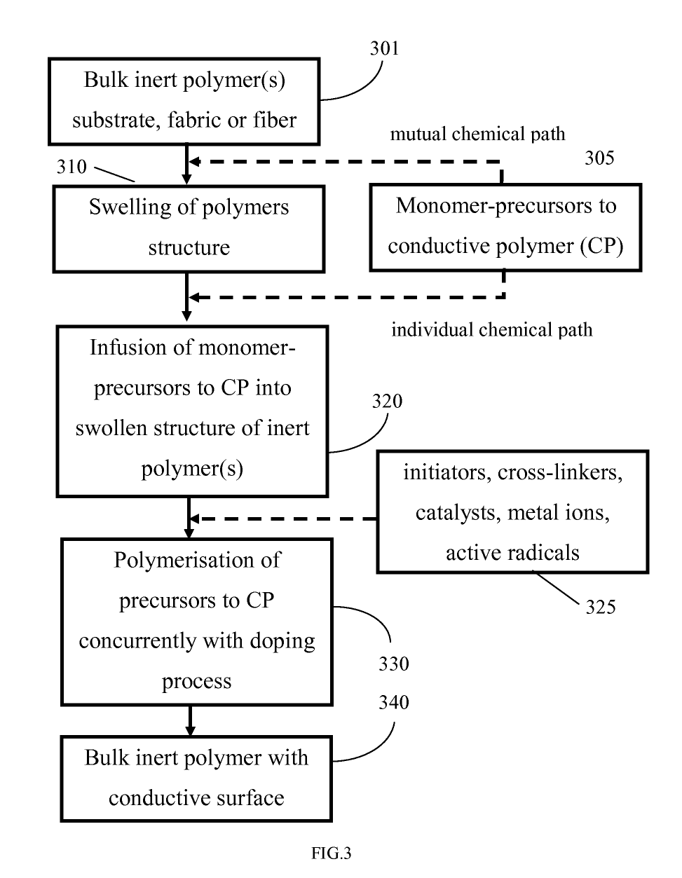

### DEFINITIONS

As used herein “IPN” means interpenetrating network.

As used herein “PET” means polyethylene terephthalate, or polyester.

As used herein “EMI” means electromagnetic interference shielding.

As used herein “OLED” means organic light-emitting diode.

As used herein “PANI” means polyaniline.

As used herein “TFPD” means thin film plasmonic device.

As used herein “PT” menas polythiophene.

As used herein “PEDOT” poly(3,4-ethylenedioxythiophene).

As used herein “PPY” means polypyrrole.

As used herein “PPS” means poly(p-phenylene sulfide.

As used herein “PPV” means poly(p-phenylene vinylene).

As used herein “PP” polypropylene.

As used herein “PMMA” means poly(methyl methacrylate).

As used herein “nylon” means aliphatic polyamide.

As used herein “PVC” means polyvinyl chloride.

As used herein “Teflon” means polytetrafluoroethylene, or PTFE.

I claim:

1. A conductive interpenetrating network (IPN) of polymers, comprising an interpenetrating network of two or more polymers, wherein at least one of the polymer networks is conducting polymer:

2. A method of producing a conducting surface on otherwise inert polymers into conductive state by interlocking with structure of conducting conjugated polymers through the IPN polymerisation.

3. In another embodiment, the present invention provides a method comprising of a swelling of inert bulk polymers by the methods there above, interpenetration of monomer precursors to conducting polymers into swollen polymers, following by the polymerization concurrently with doping process.

4. A method as in claims 1,2 and 3 of joining the polymer substrate with high dielectric constant with a conductive polymer layer, as in application in flexible electronics, non-volatile data memories, hole injection layer in OLED, and electromagnetic interference shielding (EMI); as an active layer in photonics and photovoltaics.

5. A method as in claims 1, 2 and 3 of finishing textiles and carpets for biocidal, non-static and color-change applications; or for preparing filters and membranes, for example—for water filtering of bacteria and polar molecule/substances, air and liquid filters or cigarette filters, electrodialysis and vascular grafts.

6. A method as in claims 1, 2 and 3 of producing sensors, e.g. electrochemical and capacitive sensors; condenser microphones; and wearable sensors—as elements of intelligent clothing.

7. A method as in claims 1,2 and 3 of producing active skins of crafts, for the purpose of electromagnetic radiation absorption, application in stealth technology, active and electrochromic window, and radar active surface expansion on demand.

8. A device made of conducting surface on inert bulk polymer as in claims 1, 2 and 3, and confined in the range of IPN penetration into the bulk polymer, e.g. sensors, thin film plasmonic devices (TFPD), layers for electromagnetic radiation absorption, and electrochromic windows.

9. A method of producing fully developed layers of metals and polymers up to 1-10 micrometers, by furthering the initial IPN as a substrate for the deposition of conductive layers by methods of self assembling on statically charged surfaces, electroplating and vacuum metallisation on biased substrates.
